(19) United States
(12) Patent Application Publication
(10) Pub. No.: US 2017/0115951 A1
(43) Pub. Date: Apr. 27, 2017

(54) Determining a Representative Audio Album Image

(71) Applicant: Microsoft Technology Licensing, LLC, Redmond, WA (US)

(72) Inventors: Alex Read, Seattle, WA (US); Jeff Abraham, Seattle, WA (US); Oliver Lee, Seattle, WA (US); Tyler Pasch, Seattle, WA (US); Nicolas Moreau, Paris (FR)

(73) Assignee: Microsoft Technology Licensing, LLC, Redmond, WA (US)

(21) Appl. No.: 14/919,656

(22) Filed: Oct. 21, 2015

(51) Int. Cl. G06F 3/16

(52) U.S. Cl. CPC G06F 3/16

(57) ABSTRACT

In one embodiment, a digital audio player may select an album art file to represent an audio album from multiple possible art files. The digital audio player may store an audio album organized by a content provider compiling multiple audio tracks from multiple audio sources. The digital audio player may check a track art file set associated with the multiple audio tracks from the multiple audio sources. The digital audio player may apply an art selection criteria specifying a presentation of an image to a user to the track art file set. The digital audio player may select an album art file by applying the art selection criteria to the track art file set. The digital audio player may display the album art file to a user to represent the audio album.

### BACKGROUND

A digital audio player may acquire a digital audio file from a number of sources. The user may use a desktop or laptop computer to capture, or “rip”, a digital file from a compact disc. The desktop or laptop computer may then act as a digital audio player or may transfer the digital audio file to a portable digital audio player. The digital audio player may store the digital audio file in a network storage account, or “cloud” storage account. Alternately, the digital audio player may retrieve the digital audio file from a network audio library that provides digital audio files for download over the internet, such as AppleMusic® or Amazon Music®.

A content provider, such as a musician, a comedian, or a producer, may organize these audio files into an audio album. An audio album has one or more audio files, referred to as audio tracks. An audio album differs from a playlist, in that an audio album is organized by the content provider, while a playlist is organized by the user. The content provider may provide additional media objects in the audio album, such as videos, album art, back cover art, reviews, and other complementary metadata. The content provider may embed this metadata in each audio file.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to selecting an album art file to represent an audio album from multiple possible art files. The digital audio player may store an audio album organized by a content provider compiling multiple audio tracks from multiple audio sources. The digital audio player may check a track art file set associated with the multiple audio tracks from the multiple audio sources. The digital audio player may apply an art selection criteria specifying a presentation of an image to a user to the track art file set. The digital audio player may select an album art file by applying the art selection criteria to the track art file set. The digital audio player may display the album art file to a user to represent the audio album.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a device network.

FIG. 2 illustrates, in a block diagram, one embodiment of a computing device.

FIG. 3 illustrates, in a block diagram, one embodiment of an audio album architecture.

FIG. 4 illustrates, in a block diagram, one embodiment of an audio track.

FIG. 5 illustrates, in a flowchart, one embodiment of a method for selecting an audio album art file for display.

FIG. 6 illustrates, in a flowchart, one embodiment of a method for retrieving a track art file set.

FIG. 7 illustrates, in a flowchart, one embodiment of a method for applying an art selection criteria.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a digital audio player, a computing device, or a machine-implemented method.

In one embodiment, a digital audio player may select an album art file to represent an audio album from multiple possible art files. The digital audio player may store an audio album organized by a content provider compiling multiple audio tracks from multiple audio sources. The digital audio player may check a track art file set associated with the multiple audio tracks from the multiple audio sources. The digital audio player may apply an art selection criteria specifying a presentation of an image to a user to the track art file set. The digital audio player may select an album art file by applying the art selection criteria to the track art file set. The digital audio player may display the album art file to a user to represent the audio album.

Each audio track of an audio album may have a set of metadata about the audio album as a whole. The metadata for one audio track may sometimes conflict with the information on other audio tracks in the same audio album. For example, two local files may share identical “Album Artist” and “Album Tide” metadata, causing them to be grouped into the same album. However, those two files may have different images specified for “Album Cover”, leading to a conflict.

A digital audio player may deterministically choose a representative image for an audio album having tracks and associated album art files from various sources, such as local files, cloud files, catalog streaming tracks, and other sources. The content provider may designate the representative image that acts as album art. The digital audio player may store the representative image digitally as an album art file. Since each audio track in an audio album may be associated with a different album art file, the digital audio play may select an album art file among the various album art files to use for the audio album as a whole. The various album art files may store the same representative image using different encodings, resolutions, and other differences in metadata factors beyond the actual image.

The digital audio player may combine audio tracks from various sources into a unified audio album. The audio tracks may originate from local audio files on the digital audio player, storage audio files in a network storage service, or from a collection of music catalog tracks stored on a network audio library. Each of the audio tracks of the audio album may have similar metadata or metadata that varies from track to track. For an album art image, an audio track may have an album art file embedded into the audio track, a pointer or a link to art embedded in the audio track, or an identifier associated with the audio track referencing a network audio library. In order to display the optimal album art image for the audio album as a whole, the digital audio player may consider a track location or source, a digital rights management state, a file size, and other identifiers. The digital audio player may focus on factors that provide a consistent user experience, showing the same album art file regardless of the user device acting as the digital audio player. Alternately, the digital audio player may focus on factors that provide a user experience optimized to the device used, factoring a device form factor into the decision. For example, the audio digital player may use a larger album art file for digital audio players that have larger storage or better screen resolution and smaller album art files for digital audio players that have smaller storage or less screen resolution.

The digital audio file player may identify if the audio album has an audio track that is a local audio track with an embedded track art file. The track art file is the album art file associated with a specific audio track. The digital audio player may sort the audio album by a track number representing the audio tracks position in the album. The digital audio player may then sort any audio tracks with the same album position, such as a duplicate track, by file size with the largest audio track first. The digital audio player may then use the first embedded track art file that does not have a digital right management issue.

If no local audio tracks have embedded art, the digital audio file player may identify if the audio album has an audio track with an embedded track art file stored with a network storage service. The digital audio player may sort the audio album by track number. The digital audio player may then use the first embedded track art file found in the network storage service.

If no audio tracks in network storage have embedded art, the digital audio file player may identify if the audio album has an audio track with a network storage service containing a link to a track art file in a network audio library. The digital audio player may sort the audio album by track number. The digital audio player may then use the first linked track art file from the network audio library found in the network storage service.

If no audio tracks in network storage linked to a track art file in a network audio library, the digital audio file player may identify if the audio album has an audio track with a network storage service containing a link to a track art file in a matching service. A matching service identifies an audio track based on audio track metadata or content. The digital audio player may sort the audio album by track number. The digital audio player may then use the first linked track art file from the matching service found in the network storage service.

If no audio tracks in network storage linked to a track art file in a matching service, the digital audio file player may identify if the audio album has an audio track with a network storage service identifiable by a matching service having the track art file. The digital audio player may sort the audio album by track number. The digital audio player may then use the first identified track art file from the matching service found in the network storage service.

If no audio tracks in network storage provide any track art files, the digital audio file player may identify if the audio album has an audio track from a network audio library. The digital audio player may sort the audio album by track number. The digital audio player may then use the first identified track art file from the network audio library. If none are available, the digital audio player may use a blank album art file depicting a gray screen.

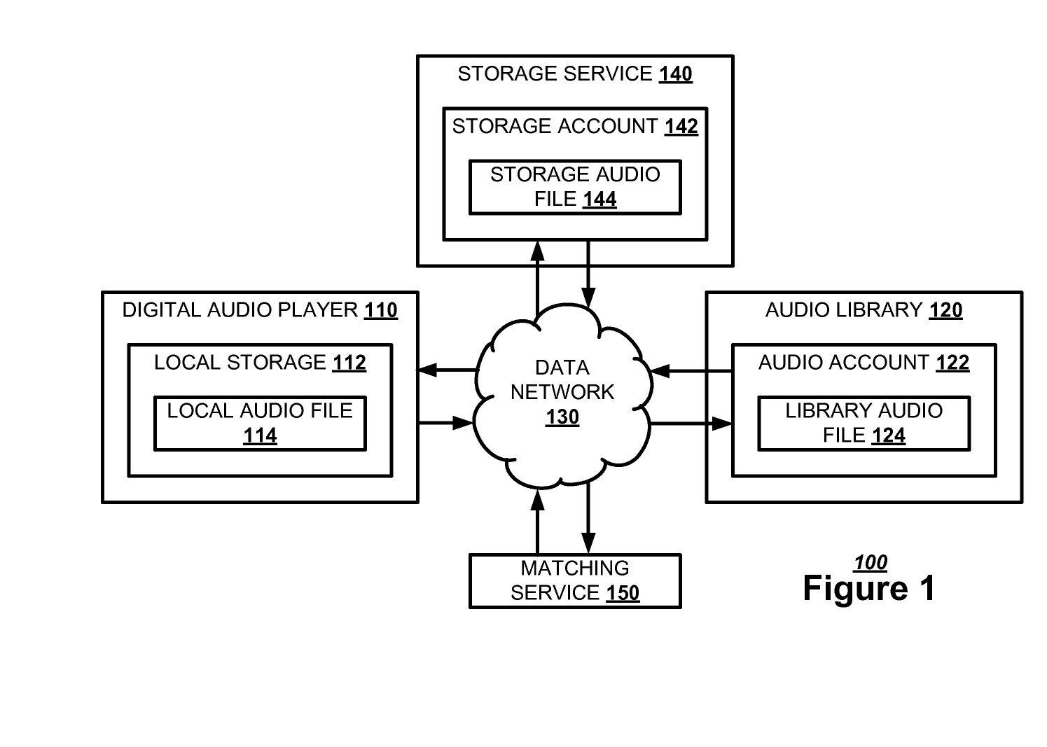

FIG. 1 illustrates, in a block diagram, one embodiment of a device network 100. A user may use a digital audio player 110 that has a local data storage 112 storing a digital audio file as a local audio file 114 that may be played by the digital audio player. The digital audio player 110 may be a desktop computer, a laptop computer, a tablet, a smart phone, or a dedicated digital audio player. The local digital audio file 114 may be a song, a comedy track, or other audio file. The user may directly load the local audio file 114 onto the digital audio player 110 via a direct input, such as a universal serial bus port or a compact disc/digital video disc player, or from a personal computer via a local area network.

Alternately, the digital audio player 110 may access a network audio library 120, or digital audio provider, via a data network connection 130. The network audio library 120 may be implemented on a single server or a distributed set of servers, such as a server farm. The data network connection 130 may be an internet connection, a wide area network connection, a local area network connection, or other type of data network connections. The user may implement the digital audio player 110 to create a network audio account 122 for the network audio library 120. The user may access the network audio account 122 to acquire a library audio file 124. The digital audio player 110 may download the library audio file 124 over the data network 130. Alternately, the network audio library may associate the library audio file 124 with the network audio account 122 without downloading the library audio file 124 to the digital audio player 110. The digital audio player 110 may then stream the library audio file 124 over the data network 130 as desired by the user. Thus, the user may access the library audio file 124 using a variety of digital audio players 110 associated with the user.

The user may keep the audio file separate from the network audio library 120, while preserving the ability to access from multiple devices, by using a network storage service 140. The network storage service 140, or “cloud” storage service, is a network service nominally separate from the network audio library 120, although both may be run by the same company. The network storage service 140 may be implemented on a single server or a distributed set of servers, such as a server farm. The user may establish a network storage account 142 to store the digital audio file as a storage audio file 144 at the network storage service 140. The user may then access the storage audio file 144 from a variety of digital audio players 110.

The digital audio player 110 may have a local audio file 114 of an unknown provenance. The digital audio player 110 may use a matching service 150, such as GraceNote® or Shazam®, to use content and metadata clues present in the local 114 audio file to identify information about the local audio file 114, such as tide, artist, or album. The digital audio player 110 may connect to the matching service 150 via the data network 130. The matching service 150 may be implemented on a single server or a distributed set of servers, such as a server farm.

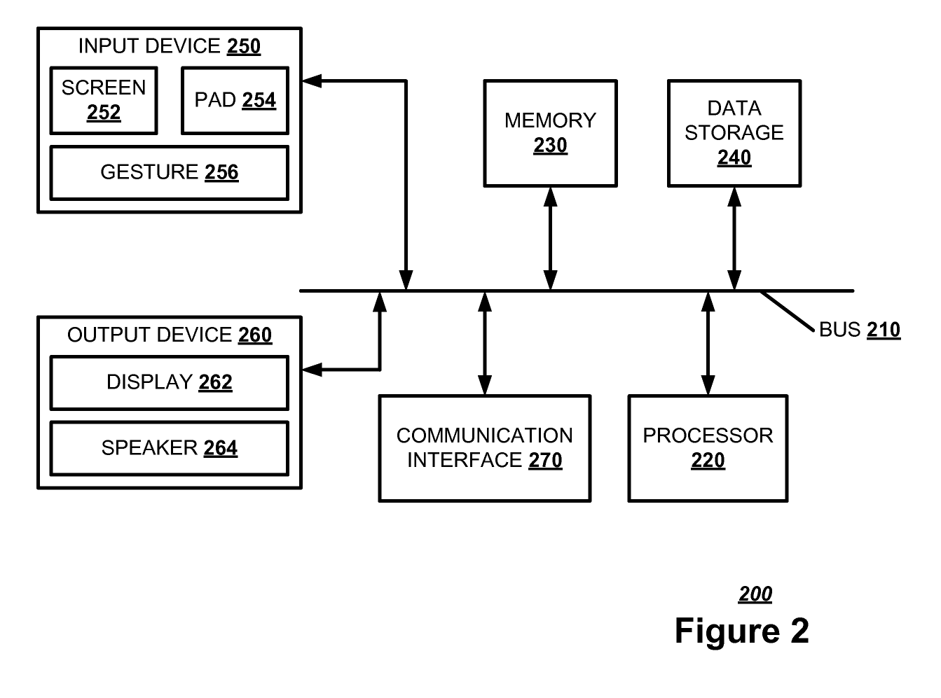

FIG. 2 illustrates a block diagram of an exemplary computing device 200 which may act as a digital audio player, a network audio server, or a network storage server. The computing device 200 may combine one or more of hardware, software, firmware, and system-on-a-chip technology to implement a digital audio player, a network audio server, or a network storage server. The computing device 200 may include a bus 210, a processing core 220, a memory 230, a data storage 240, an input device 250, an output device 260, and a communication interface 270. The bus 210, or other component interconnection, may permit communication among the components of the computing device 200.

The processing core 220 may include at least one conventional processor or microprocessor that interprets and executes a set of instructions. The processor may be configured to check a track art file set associated with the multiple audio tracks from the multiple audio sources. A track art file of the track art file set may be sourced to at least one of a local data storage on the digital audio player, a network audio library that provides an audio track for download, a network storage service that provides storage to a user over a network, and a matching service identifying an audio track based on at least one of audio track metadata and audio content. The processor may be configured to apply an art selection criteria specifying a presentation of an image to a user to the track art file set. The art selection criteria may prioritize art consistency across user devices, so that the user sees the same image regardless of the device used. The art selection criteria may prioritize a data location for a track art file of the track art file set. The art selection criteria may factor at least one of a device form factor, a file size, and a digital rights management description. The processor may be configured to select an album art file by applying the art selection criteria to the track art file set. The processor may be configured to identify a track art identifier identifying a track art file associated with an audio track of the audio album.

The memory 230 may be a random access memory (RAM) or another type of dynamic data storage that stores information and instructions for execution by the processing core 220. The memory 230 may also store temporary variables or other intermediate information used during execution of instructions by the processor 220. The memory 230 may be configured to store an audio album organized by a content provider compiling multiple audio tracks from multiple audio sources. The memory 230 may be configured to group an audio track into the audio album based on a metadata description describing the audio track. The memory 230 may be configured to retrieve a track art file of the track art file set as an embedded art file from an audio track of the audio album.

The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing digital audio files.

The input device 250 may include one or more conventional mechanisms that permit a user to input information to the computing device 200, such as a keyboard, a mouse, a voice recognition device, a microphone, a headset, a touch screen 252, a touch pad 254, a gesture recognition device 256, etc. The input device 250 may be configured to receive a user input indicating a user album art override to select the album art file.

The output device 260 may include one or more conventional mechanisms that output information to the user, including a display 262, a printer, one or more speakers 264, a headset, a vibrator, or a medium, such as a memory, or a magnetic or optical disk and a corresponding disk drive. The display 262 may be configured to display the album art file to a user to represent the audio album. The display 262 may be configured to display the album art file to the user to represent an audio track of the audio album. The display may be configured to display a blank art file as the album art file when the track art file set is a null set.

The communication interface 270 may include any transceiver-like mechanism that enables computing device 200 to communicate with other devices or networks. The communication interface 270 may include a network interface or a transceiver interface. The communication interface 270 may be a wireless, wired, or optical interface. The communication interface may be configured to match an audio track of the audio album to a track art file of the track art file set stored with a matching service identifying an audio track based on at least one of audio track metadata and audio content.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

The digital audio player may organize the various audio files, or audio tracks, into audio albums and playlist. A playlist is a collection of audio tracks selected and organized by the user. An audio album is a collection of audio tracks selected and organized by a content provider. The content provider may be a musician, a comedian, or a producer. The audio album has a distinct order and content list that is the same for each user, as opposed to a playlist which may differ from user to user. While the audio album is created holistically by the content provider, the user may acquire audio tracks of the audio album from multiple content services. Similarly, the user may acquire the same audio track from multiple sources.

Generally, the content provider may provide an album art file storing a representative image selected by the content provider that visually represents the audio album to the user. The digital audio player may display the album art file to the user while playing an audio track of the audio album. As various audio tracks may be retrieved from various content services, each track may provide different versions of the album art file. While each album art file may or may not be based off of the same album image, each file may have different resolutions and digital rights management metadata.

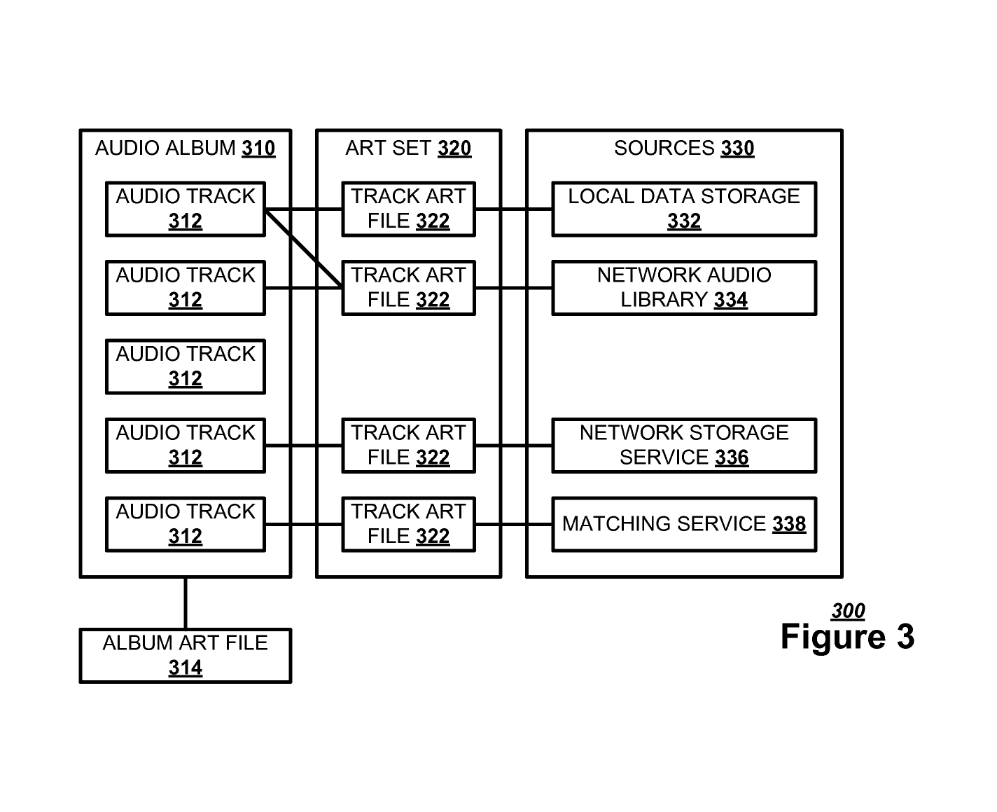

FIG. 3 illustrates, in a block diagram, one embodiment of an audio album architecture 300. An audio album 310 may have one or more audio tracks 312. Each audio track 312 is a digital representation of a distinct clip of audio. The audio album 310 may be associated with a track art file set 320. The track art file set 320 may have any number of track art files 322. Each audio track 312 of the audio album 310 may correspond to one or more track art file 322 of the track art file set 320. An audio track 312 may have no track art file 322 associated with that audio track 312. If none of the audio tracks 312 have an associated track art file 322, the track art file set 320 is determined to be a null set. The digital audio player may select a track art file 322 of the track art file set 320 to be the album art file 314 for the audio album 310 based on an art selection criteria.

The track art file set 320 may receive the various track art files 322 from a variety of sources 330. The digital audio player may receive a track art file 322 from a local data storage 332. The local data storage 332 may be a data storage device located on the digital audio player. The digital audio player may receive a track art file 322 from a network audio library 334. The network audio library 334 is a network service that provides audio tracks to a digital audio player. The digital audio player may receive a track art file 322 from a network storage service 336. The network storage service 336 is a network service that provides storage for a computing device. The digital audio player may receive a track art file 322 from a matching service 338. The matching service 338 is a network service that provides track metadata, such as a track art file 322, based on content and other metadata.

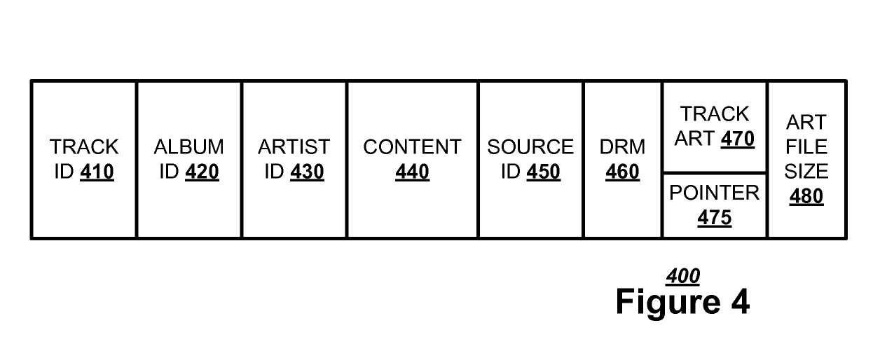

The audio track may contain information beyond the audio content. FIG. 4 illustrates, in a block diagram, one embodiment of an audio track 400. The audio track 400 may have an audio track identifier (ID) 410 identifying the audio track 400. The audio track identifier 410 may be an audio track title, an identification number corresponding to an identification number in an audio database, or other identifier. The audio track 400 may have an album identifier 420 identifying the audio album containing the audio track 400. The album identifier 420 may be an album title, an identification number corresponding to an identification number in an audio database, or other identifier. The audio track 400 may have an artist identifier 430 identifying the artist that created the audio track 400. An album may have a different artist for different tracks of the album. The audio track 400 may have content 440 that, when interpreted by the digital audio player, produces audio content. The audio track 400 may have a source identifier 450, indicating the source of the audio track 400 or the audio track metadata.

The audio track 400 may have a digital rights management (DRM) field 460 describing the legal rights associated with the audio track, such as copyright for both the content and any associated art. The audio track 400 may have track art file 470 embedded in the audio track 400. Alternately, the audio track 400 may have a pointer 475 indicating the location that the digital audio player may access a track art file 470, such as a network audio library. The audio track 400 may have an art file size 480 indicating the size of the track art file 470.

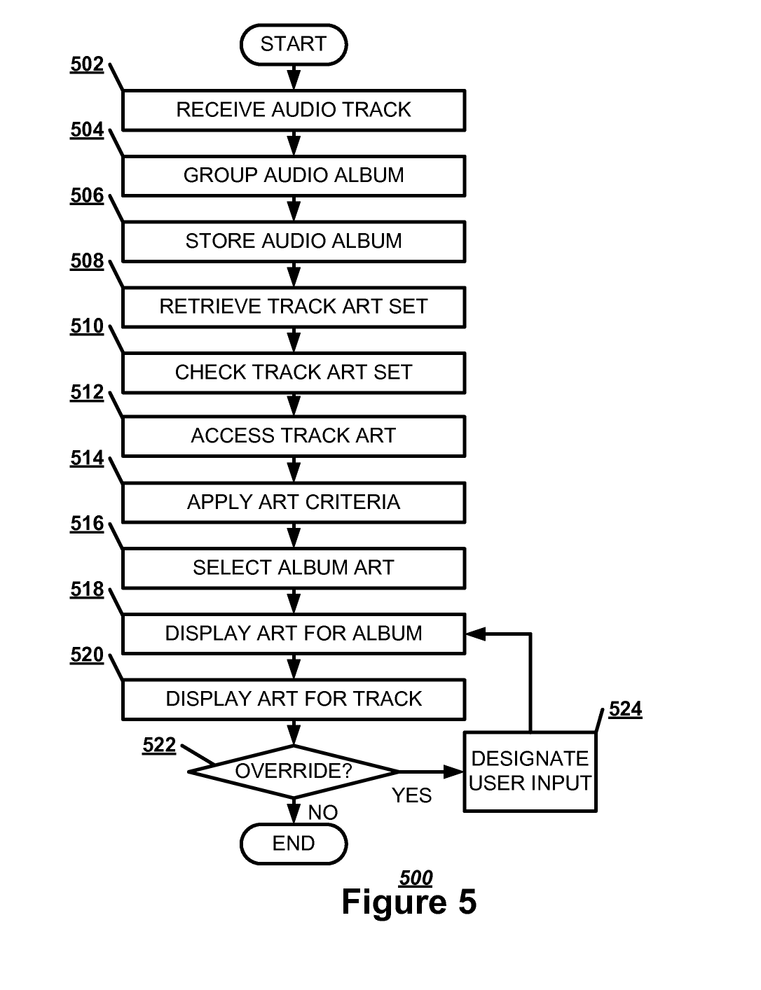

FIG. 5 illustrates, in a flowchart, one embodiment of a method 500 for selecting an audio album art file for display. The digital audio player may receive an audio track from an audio source, such as a local data storage, a network audio library, a network storage service, a matching service, or other source (Block 502). The digital audio player may group an audio track into an audio album organized by a content provider based on a metadata description of the audio track (Block 504). The digital audio player may store the audio album organized by a content provider compiling multiple audio tracks from multiple audio sources (Block 506). The digital audio player may retrieve a track art file set associated with an audio album from one or more sources (Block 508). The digital audio player may check the track art file set associated with the multiple audio tracks from the multiple audio sources (Block 510). The digital audio player may access a track art file of the track art file set sourced to at least one of a local data storage, a network audio library, a network storage service, a matching service, or other source (Block 512). The digital audio player may apply an art selection criteria specifying a presentation of an image to a user to the track art file set (Block 514). The digital audio player may select an album art file by applying the art selection criteria to the track art file set (Block 516). The digital audio player may display the album art file to a user to represent the audio album (Block 518). The digital audio player may display the album art file to the user to represent the audio track of the audio album (Block 520). If the digital audio player receives a user input indicating a user album art override from the user (Block 522), the digital audio player may designate the user input as the album art file (Block 524).

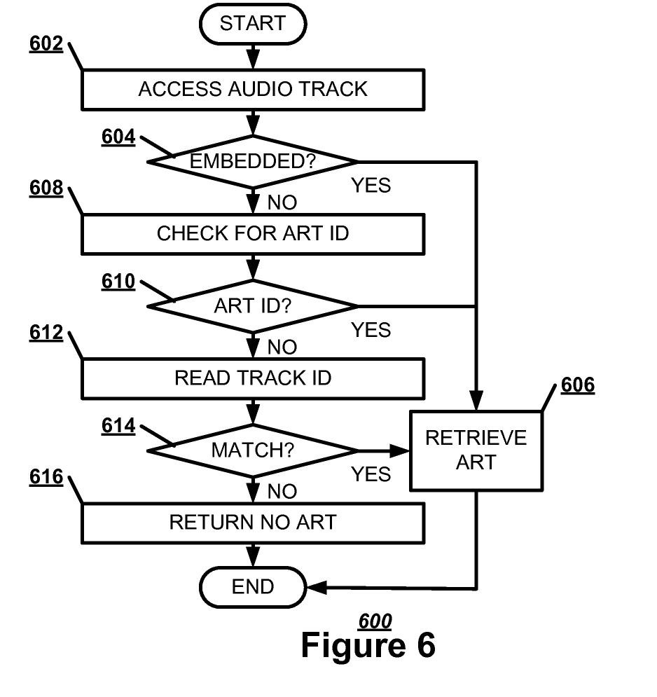

FIG. 6 illustrates, in a flowchart, one embodiment of a method 600 for retrieving a track art file set. The digital audio player may access an audio track of the audio album (Block 602). If the digital audio player detects an embedded art file in the audio track (Block 604), the digital audio player may retrieve the track art file of the track art file set as an embedded art file from the audio track of the audio album (Block 606). The digital audio player may check the audio track for a track art identifier (Block 608). If the digital audio player identifies a track art identifier associated with an audio track of the audio album (Block 610), the digital audio player may retrieve the track art file of the track art file set from the network audio library based on the track art identifier (Block 606). The digital audio player may read the track identifier for the audio track (Block 612). If the digital audio player matches an audio track of the audio album to a track art file of the track art file set stored with a matching service identifying an audio track based on at least one of audio track metadata and audio content (Block 614), the digital audio player may retrieve the track art file of the track art file set from the network audio library based on the track art identifier (Block 606). Otherwise, the digital audio player may return no track art file when none is available (Block 616).

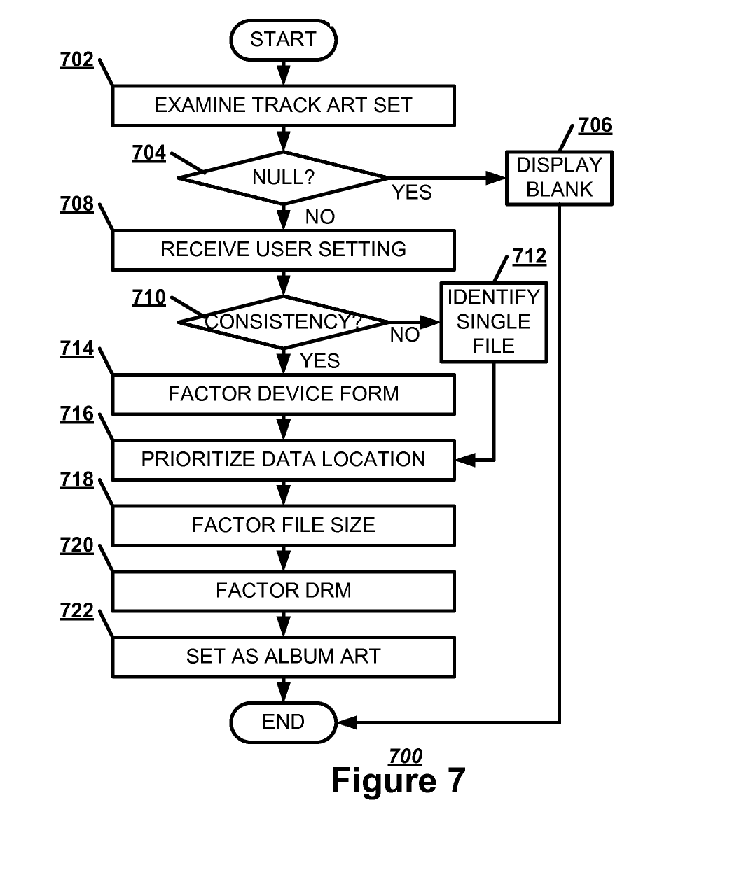

FIG. 7 illustrates, in a flowchart, one embodiment of a method 700 for applying an art selection criteria. The digital audio player may examine the track art file set (Block 702). If the track art file set is a null set (Block 704), the digital audio player may display a blank art file as the album art file when the track art file set is a null set (Block 706). The digital audio player may receive a user setting from the user organizing the art selection criteria (Block 708). If the digital audio player prioritizes art consistency across user devices in the art selection criteria (Block 710), the digital audio player may identify a single album art file to be used across the user devices (712). Otherwise, the digital audio player may factor a device form factor into art selection criteria (Block 714). The digital audio player may prioritize a data location for a track art file of the track art file set to determine the album art file from the track art file set (Block 716). The digital audio player may factor a file size into the art selection criteria (Block 718). The digital audio player may factor a digital rights management description into the art selection criteria (Block 720). The digital audio player may set a track art file indicated by the art selection criteria as an album art file (Block 722).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to store desired program code means in the form of computer-executable instructions or data structures, as opposed to propagating media such as a signal or carrier wave. Computer-readable storage media explicitly does not refer to such propagating media. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A digital audio player, comprising:
memory configured to store an audio album organized by a content provider compiling multiple audio tracks from multiple audio sources;
a processing core having at least one processor configured to check a track art file set associated with the multiple audio tracks from the multiple audio sources, further configured to apply an art selection criteria specifying a presentation of an image to a user to the track art file set, and also configured to select an album art file by applying the art selection criteria to the track art file set; and
a display configured to display the album art file to the user to represent the audio album.

2. The digital audio player of claim 1, wherein the memory is configured to group an audio track into the audio album based on a metadata description describing the audio track.

3. The digital audio player of claim 1, wherein the display is configured to display the album art file to the user to represent an audio track of the audio album.

4. The digital audio player of claim 1, further comprising:
an input device configured to receive a user input indicating a user album art override to select the album art file.

5. The digital audio player of claim 1, wherein a track art file of the track art file set is sourced to at least one of a local data storage on the digital audio player, a network audio library that provides an audio track for download, a network storage service that provides storage to the user over a network, and a matching service identifying the audio track based on at least one of audio track metadata and audio content.

6. The digital audio player of claim 1, wherein the memory is configured to retrieve a track art file of the track art file set as an embedded art file from an audio track of the audio album.

7. The digital audio player of claim 1, further comprising:
a communication interface configured to match an audio track of the audio album to a track art file of the track art file set stored with a matching service identifying an audio track based on at least one of audio track metadata and audio content.

8. The digital audio player of claim 1, wherein the processing core is further configured to identify a track art identifier identifying a track art file associated with an audio track of the audio album.

9. The digital audio player of claim 1, wherein the art selection criteria prioritizes art consistency across user devices.

10. The digital audio player of claim 1, wherein the art selection criteria factors at least one of a device form factor, a file size, and a digital rights management description.

11. The digital audio player of claim 1, wherein the art selection criteria prioritizes a data location for a track art file of the track art file set.

12. The digital audio player of claim 1, wherein the display is configured to display a blank art file as the album art file when the track art file set is a null set.

13. A computing device, having a memory to store an audio album organized by a content provider compiling multiple audio tracks from multiple audio sources, the computing device configured to group an audio track into the audio album based on a metadata description of the audio track, the computing device further configured to check a track art file set associated with the multiple audio tracks from the multiple audio sources, the computing device also configured to apply an art selection criteria specifying a presentation of an image to a user to the track art file set, the computing device additionally configured to select an album art file by applying the art selection criteria to the track art file set, and the computing device further configured to display the album art file to the user to represent the audio album.

14. The computing device of claim 13, wherein the computing device is also configured to retrieve a track art file of the track art file set as an embedded art file from an audio track of the audio album.

15. The computing device of claim 13, wherein the computing device is also configured to match an audio track of the audio album to a track art file of the track art file set stored with a matching service identifying an audio track based on at least one of audio track metadata and audio content.

16. The computing device of claim 13, wherein the computing device is also configured to identify a track art identifier identifying a track art file associated with an audio track of the audio album.

17. The computing device of claim 13, wherein the computing device is also configured to prioritize art consistency across user devices in the art selection criteria.

18. The computing device of claim 13, wherein the computing device is also configured to prioritize a data location for a track art file of the track art file set to determine the album art file.

19. A machine-implemented method, comprising:
grouping an audio track into an audio album organized by a content provider based on a metadata description of the audio track;
storing the audio album compiling multiple audio tracks from multiple audio sources;
checking a track art file set associated with the multiple audio tracks from multiple audio sources;
prioritizing a data location for a track art file of the track art file set to determine an album art file from the track art file set; and
displaying the album art file to a user to represent the audio album.

20. The method of claim 19, further comprising:
displaying a blank art file as the album art file when the track art file set is a null set.
